(19) United States
(12) Patent Application Publication
(10) Pub. No.: US 2024/0149332 A1
(43) Pub. Date: May 9, 2024

(54) SYSTEM AND METHOD FOR ADDITIVE METAL CASTING

(71) Applicant: Magnus Metal Ltd., Tzora (IL)

(72) Inventors: Roi Levi, Rehovot (IL); Hani Farran, Ramat Gan (IL); Emil Weisz, Modiin-Macabim-Reut (IL); Hana Arini Yadid, Gedera (IL)

(73) Assignee: Magnus Metal Ltd., Tzora (IL)

(21) Appl. No.: 17/983,832

(22) Filed: Nov. 9, 2022

(51) Int. Cl. B22C 9/06; B22C 3/00; B22F 10/22; B22F 10/64; B22F 10/68; B33Y 10/00; B33Y 80/00

(52) U.S. Cl. CPC B22C 9/061; B22C 3/00; B22F 10/22; B22F 10/64; B22F 10/68; B33Y 10/00; B33Y 80/00

(57) ABSTRACT

A mold construction system is presented for use in additive manufacturing of a metal object. The system comprises: at least one mold provision device controllably operable to form one or more mold regions defining one or more respective object regions in a production layer, and configured to receive molten metal deposited to each object region; and a control system operating each mold provision device in accordance with a predetermined building plan. The mold provision device, in accordance with said predetermined building plan, creates each mold region of each production layer with at least one metal-facing zone configured to define at least one cavity forming the object region to receive the molten metal therein. The metal-facing zone comprises a predetermined arrangement of spaced-apart sites of relatively weak mechanical properties relative to spaces between said sites within said mold material. The arrangement of the spaced-apart sites is selected in accordance with properties of the metal object and molten metal deposition.

### TECHNOLOGICAL FIELD

The present disclosure is in the field of additive manufacturing of relatively large objects and relates to a method and system for mold construction for additive metal casting.

### BACKGROUND AND BACKGROUND ART

Casting is one of the oldest material-forming methods still used today. The principal process had not changed since 3200 BC when bronze was melted and poured into a stone mold. Metal casting is defined as the process in which molten metal is poured into a mold that contains a hollow cavity of a desired geometrical shape and allowed to cool down to form a solidified part.

Most of the world's demand for metal cast is addressed nowadays by traditional casting techniques. While automation solutions are applied, traditional casting involves the global production of molds and the global application of molten metal. For example, additive manufacturing techniques are used for mold fabrication with the implementation of mold curing, sintering, or otherwise mold curing (partially or fully) as a global operation before metal pouring. Molten metal is poured into fully fabricated molds.

Currently available metal additive manufacturing technologies address complex design and low volume applications of relatively small-size parts. Scaling from small parts to large parts of hundreds and thousands Kg. is not trivial. In several currently available metal additive manufacturing technologies, size and weight scaling-up involve part deformation, distortion, shrinking, fracture, cracking, and more.

Despite the advantages of metal additive manufacturing, the associated high cost, low throughput, and scaling-up challenges prevent the adoption of additive techniques for widespread industrial use, especially for manufacturing iron and steel parts.

Casting is widely used for industrial manufacturing of large production quantities and sizable parts in a one-piece cast. Metal casting can produce complex shapes and features like internal cavities or hollow sections can be easily formed. Materials that are difficult or expensive to manufacture using other manufacturing processes can be cast. Compared to other manufacturing processes, exiting casting is cheaper for medium to large metal quantities.

Modern metal casting also has several disadvantages. Patterns and molds are time-consuming and expensive to make. Additive manufacturing processes, such as, e.g., binder jetting, are typically used to create patterns and molds. However, the fabrication of patterns and molds extend the lead time and limit design flexibility for modifications and adaptations. Additionally, minor post-processing or significant additional post-processing operations are needed for certain applications. Furthermore, metal casting is a hazardous activity, as it involves many elements such as furnaces, molds, cooling areas, and additional tooling that are manually operated and exposed, while operating at very high temperatures.

US Patent Publication No. 2020/0206810, assigned to the assignee of the present application, describes a method and an apparatus for additive casting of parts, wherein the method may include depositing, on a build table, a first portion of a mold, such that, the depositing may be performed layer by layer; pouring liquid substance into the first portion of the mold to form a first casted layer; solidifying at least a portion of the first casted layer; depositing a second portion of the mold, on top of the first portion of the mold; pouring the liquid substance into the second portion of the mold to form a second casted layer, on top of at least a portion of the first casted layer; and solidifying at least a portion of the second casted layer. The method may further include pre-heating each casted layer prior to the pouring of an additional casted layer.

### GENERAL DESCRIPTION

There is a need in the art for a novel additive metal casting technique that facilitates high-volume manufacturing with high throughput.

In order to enable high production yield and provide high precision of the casted parts, the mold being produced during the additive metal casting should withstand not only high hydraulic pressure of the molten metal on the mold walls, but also multiple cycles of casted metal heating, which lead to metal expansion, thereby exerting additional pressure onto the mold walls.

As described in the above-mentioned patent publication US2020/0206810, assigned to the assignee of the present application, the additive metal casting can be performed together with additive mold casting. The inventors have identified another problem associated with a need for heating the working area of the object region, to a pre-deposition target temperature needed prior to depositing the metal in the object region. This heating is required to affect bonding of the molten metal with the solidified metal of the preceding metal layers (deposited during previous casting cycles and already cooled down). The pre-deposition target temperature may be below, equal to or above a melting temperature of the metallic object being manufactured. Heating of already solidified metal inside the mold is accompanied by a volume change and exerts pressure on the mold walls during the phase change, causing significant stress inside the mold material and may lead to failures of the mold.

The technique of the present disclosure provides a novel mold construction system for use during additive casting of metal objects. The mold construction system provides unique mold regions which are not only configured to define the shape of the metal object, but also to prevent leakage of the molten metal during additive casting, thereby preserving the desired shape of the metal object, increasing thus the casting process yield and safety.

The mold construction system of the present disclosure is configured and operable to produce, in each production layer, one or more mold regions (e.g., ceramic-based mold region(s)), each mold region including at least one metal-facing zone defining at least one cavity forming a respective object region being produced in said production layer. The at least one metal-facing zone of the mold region has a predetermined arrangement of spaced-apart sites of relatively weak mechanical properties relative to their surroundings (spaces between them). The arrangement of the spaced-apart sites is selected in accordance with properties of the metal object and molten metal deposition. This configuration of the mold region provides enhanced stability against molten metal breach.

It should be noted that according to the technique of the present disclosure, additive metal casting includes fabricating a mold structure concurrently with a metal object structure, where this fabrication is implemented in the layer-by-layer additive manner. The layer is termed here a “production layer”. Each production layer (in some embodiments, except for a lowermost layer) includes one or more “mold regions” each defining and surrounding a respective “object region” of the metal object structure. The closed-loop mold region in the production layer being fabricated defines a cavity into which the molten metal of the object region is deposited. Typically, the first (lowermost) layer includes the closed-loop mold region and a bottom layer of the cavity made solely out of the mold material.

According to the technique of the present disclosure, the additive casting of a metal object is performed by successive creation of production layers, each including one or more mold regions defining respective one or more object regions. The resulting structure includes one or more parts of the object (each formed by a stack of object regions), where each part is surrounded by the mold structure (a stack of the mold regions). The surface of the object is adhered to the metal-facing surface of the respective mold structure. Upon completing the fabrication of all of the production layers, the mold structure can then be properly removed from the object using any known suitable technique.

Thus, in the description below, the term “mold region” refers to the mold part/portion within the single production layer. The terms “mold structure” and “mold” are used interchangeably referring to all or part of the stack of mold regions in all or several production layers.

It should be understood that in the general field of mold fabrication by 3D printing, the term “mold” is commonly used to describe a complete mold structure, fully sintered/cured before metal pouring. The technique of the present disclosure deals with additive fabrication (production layer-by-production layer fabrication) of a stack of mold regions where, within each mold region, additive casting of a respective stack of object regions in the cavity being formed by the respective mold region is performed. In this connection, it should be noted that the mold regions of different production layers may or may not be of the same size and geometry, since this depends on the specific geometries and sizes of the respective object regions.

The mold region may be configured as a closed-loop region defining a cavity for the object region. In some cases, depending on the geometry of the object region, the mold region associated with and defining said object region may be a multiple-part region. For example, in case the object region is a ring-like region, the mold region has a closed-loop part and an insert part which together define the ring-like cavity for the object region.

The mold region can be a single-zone region including a metal-facing zone defining the cavity for the object region, or may be a multi-zone region, and also one or more of the zones may include two or more sub-zones. In case of multi-zone configuration of the mold region, the zones of the mold region are differently located with respect to the associated object region, including a metal-facing zone which defines the cavity for the object region, and one or more metal-nonadjacent zones around the metal=facing zone.

Considering the above example of the ring-like object region, the mold region includes a two-part metal-facing zone, or, in other words, the mold region includes two metal-facing zones. Such two parts of the metal-facing zone, or two metal-facing zones, define, respectively, opposite surfaces of the cavity of the ring-like object region.

Further, in case of multi-zone or multi-sub-zone configuration, the zones, as well as sub-zones, include different zones/sub-zones which are different in their mechanical properties which can be implemented by proper selection of mold material compositions and/or geometrical parameters of the zones/sub-zones.

The mold construction system of the present disclosure is configured to fabricate each mold region to receive molten metal in the cavity/object region defined by said mold region before the successive mold region (of the subsequent production layer) is constructed. The mold regions of the different production layers are cured (fully, partially, or not at all) at different points of time during the production process.

In particular, the inventors have shown that a mold shell structure having notches/grooves (constituting relatively weak sites) of less than 50 μm width on the surface of the mold region which comes in contact with the molten metal not only prevents metal passage through said notches/grooves, but also diminishes formation of cracks within the mold during additive deposition of the metal cast.

The inventors use here a qualitative description of the phenomena utilizing a concept of “breathing mode” to describe the behavior of the mold regions being fabricated by the technique of the disclosure. When the expanding metal exerts pressure on the mold walls, the arrangement of spaced-apart sites of relatively weak mechanical properties may allow some limited expansion of the metal, while limited extent of cracking may occur along the weak mechanical sites of the mold. A proper design of said sites provides for avoidance of total metal breaching/leakage through the mold cracks thanks to the surface tension of the molten metal and the small enough dimension of the allowed cracks in the mold (less than ˜50 μm width). When the metal is cooling down after being casted, it contracts back to the initial dimensions (before expansion due to e.g., post-heating) together with the mold walls which are adhered to the outer surface of the casted metallic object under production. Additional expansion-contraction cycles are exhibited in previously fabricated production layers, as the mold-object structure is manufactured, in response to heat dissipation from the currently produced production layer. The process of expansion/contraction is repeated during each and every deposition of metal in a production layer, one production layer after the other. With the implementation of weak sites, the combined mold-metal structure expands and contracts together, which is termed herein as “breathing mode”.

Thus, according to one broad aspect of the present disclosure, there is provided a mold construction system for use in additive manufacturing of a metal object, the mold construction system comprising: at least one mold provision device which is controllably operable to form one or more mold regions defining one or more respective object regions in a production layer and is configured to receive molten metal deposited to each of said one or more object regions; and a control system configured to operate said at least one mold provision device in accordance with a predetermined building plan;
wherein said at least one mold provision device is controllably operable, in accordance with said predetermined building plan, to create each mold region of each production layer with at least one metal-facing zone configured to define at least one cavity forming the object region to receive the molten metal therein, and
wherein said at least one metal-facing zone of the mold region comprises a predetermined arrangement of spaced-apart sites of relatively weak mechanical properties relative to spaces between said sites within said mold material, said arrangement of the spaced-apart sites being selected in accordance with properties of the metal object and molten metal deposition.

In some embodiments, the metal-facing zone of the mold region is a single-part zone formed as a closed-loop part defining the cavity forming the respective object region. In some other embodiments, depending on the shape of the object region, in particular when the object region has a ring-like shape, the metal-facing zone has a closed-loop part defining and an insert part defining the object region between them.

In some embodiments, the mold provision device is controllably operable to create the mold region comprising at least one metal-nonadjacent zone around the at least one metal-facing zone. In some examples, the metal-nonadjacent zone comprises two or more adjacent sub-zones differently spaced from the metal-facing zone, and these two or more sub-zones include at least two locally adjacent sub-sones having different mechanical properties.

In some embodiments, the arrangement of the spaced-apart sites is formed by a varying width of the metal-facing zone. The sites of the relatively weak mechanical properties are defined by relatively thinner segments of the metal-facing zone. The variation of width of the metal-facing zone forms a surface relief along an outer surface of said metal-facing zone.

In some embodiments, the metal-facing zone comprises said spaced-apart sites formed by air gaps spaced by segments of said metal-facing zone.

In some other embodiments, the metal-facing zone comprises said spaced-apart sites formed from the mold material of first material properties and the spaces between said sites are formed from the mold material of second material properties being different from the first material properties. Preferably, the spaced-apart sites comprise the first material properties providing relatively high compressibility as compared to compressibility provided by the second material properties of the spaces between the sites.

The first material properties may be selected to define relatively low material density of the mold material as compared to material density defined by the second material properties of the spaces between the sites.

In some embodiments, the spaced-apart sites are formed from the mold material of a first material composition and the spaces between said sites are formed from the mold material of a second material composition different from the first material composition.

In some embodiments, the arrangement of the spaced-apart sites in a successive mold region of a successive production layer is positionally aligned with the arrangement of the spaced-apart sites in a preceding mold region in the preceding production layer.

Alternatively, the arrangement of the spaced-apart sites in a successive mold region of a successive production layer is laterally shifted with respect to the arrangement of the spaced-apart sites in a preceding mold region of the preceding production layer. In yet further alternative, or as addition, the arrangement of the spaced-apart sites in a successive mold region of a successive production layer is different from the arrangement of the spaced-apart sites in a preceding mold region of a preceding production layer.

In some embodiments, the mold provision device is controllably operable to create the mold region of each of at least some of the production layers comprising an array of supporting fins arranged in a spaced-apart relationship along an outer surface of the metal-facing zone, each of the supporting fins extending in a direction from said outer surface from a location aligned with a space between the spaced-apart sites. For example, the supporting fins may be spaced from the outer surface of the metal-facing zone; or are constructed as protrusions from the outer surface of the metal-facing zone.

The supporting fins may have at least one of the following configurations: (i) the supporting fins comprise fins having substantially rectangular cross section; (i) the supporting fins comprise fins having a varying profile along a lateral cross section of the fin; (iii) the supporting fins comprise fins having a varying profile along a vertical cross section of the fin.

In some embodiments, the mold provision device is controllably operable to create the mold region comprising said metal-nonadjacent zone which is spaced-apart from said metal-facing zone by an air gap. For example, the metal-facing and metal-nonadjacent zones of the mold region are constructed from the mold material of the same material properties. Alternatively, the metal-facing and metal-nonadjacent zones of the mold region are constructed from the mold material of different material properties.

In some embodiments, the mold provision device is controllably operable to create the mold region comprising said metal-nonadjacent zone, wherein the metal-nonadjacent zone comprises a number of sub-zones comprising a first sub-zone interfacing with the metal-facing zone being configured with mechanical properties different from mechanical properties of the metal-facing zone.

The first sub-zone of the metal-nonadjacent zone may be of significantly higher compressibility than that of the metal-facing zone; and/or the metal-nonadjacent zone may further comprise a second sub-zone interfacing the first sub-zone, where said first and second sub-zones have respectively relatively high and low compressibility.

In some embodiments, the metal-nonadjacent zone comprises first and second sub-zones spaced-apart between them by an air gap, wherein the first sub-zone interfacing the air gap between the metal-facing zone and the metal-nonadjacent zone comprise an arrangement of spaced-apart sites of relatively weak mechanical properties as compared to spaces between them along said first sub-zone.

The arrangement of the spaced-apart sites of relatively weak mechanical properties in the metal-facing zone may be different from the arrangement of spaced-apart sites of relatively weak mechanical properties in the first sub-zone of the metal-nonadjacent zone.

The mold material may comprise ceramic-based material.

In some embodiments, the mold material comprise mold powder bound by mold binding material.

In some embodiments, the mold provision device comprises one or more traveling mold depositors, each traveling in a horizontal plane according to a predetermined trajectory and being associated with one or more mold material reservoirs.

In some embodiments, the mold provision device comprises one or more extruders each in fluid communication with said one or more traveling depositors.

Each traveling depositor may include at least one of the following: stirrers, tubing, and tubing loop configured to perform continuous circulation of the mold material not currently involved in deposition process.

The system may be configured to provide relative displacement between the one or more traveling depositors and the build table.

The system may include a build table configured to be placed in a temperature-controlled environment.

The said mold provision device may be configured and operable to create the mold region using one or more mold material deposition iterations.

In some embodiments, for example, for additively casting gray iron objects, the height of the object region in a production layer may be 1 mm-20 mm, realized in a single or multiple metal deposition iterations. Correspondingly, the height of the mold region may be 1 mm-20 mm. The mold region may be constructed in single or multiple mold deposition iterations. For example, utilizing ceramic-based mold material, a 6 mm height mold region may be constructed by depositing a circular mold tube of 6 mm diameter or two deposition iterations of a circular mold tube of 3 mm diameter. In another example, utilizing binder jetting for mold construction, the mold material deposited in a single iteration may have a thickness of about 100 to 150 microns. Multiple iterations are required for constructing the 6 mm height mold region.

In some embodiments, the system further comprises a surface treatment system configured and operable to apply one or more surface treatments to the mold region. The surface treatment system may be configured and operable to apply temperature treatment to the mold region to partially or fully cure mold material in said mold region.

The mold provision device may be configured and operable to create the mold region using one or more mold material deposition iterations. In this case, the surface treatment system may be configured and operable to apply the temperature treatment to the mold region after each of said one or more mold deposition iterations.

The surface treatment system may be configured and operable to perform mechanical surface treatment of at least a part of the mold region.

The surface treatment system may be further configured and operable to perform the mechanical surface treatment on surfaces of the metal-facing zone facing said cavity defined by the mold region.

The present disclosure, in its another broad aspect, presents a production part comprising: a stack of production layers, each of the production layers comprising: one or more object regions of a metal object, each object region being surrounded by a mold region having at least a metal-facing zone configured to define a cavity for the object region, wherein a surface of the metal object in said object region and a facing surface of the metal-facing zone of the mold region are physically coupled between them, and
wherein at least the metal-facing zone of the mold region has a distribution of spaced-apart sites of relatively weak mechanical properties as compared to their surroundings within said metal-facing zone of the mold region.

In yet further broad aspect of the present disclosure, it presents an additive casting system for additively casting of a metallic object by producing multiple production layers having mold regions and object regions within cavities defined by the mold regions, one current production layer after the other on a movable build table up to a top production layer. The additive casting system comprises the above-described mold construction system, and an object construction device configured and operable to construct each current production layer by depositing molten metal in each of one or more object regions defined by each of the respective one or more mold regions in said current production layer.

The object construction device comprises one or more molten metal depositors; and a control system configured to operate said one or more molten metal depositors in accordance with a predetermined building plan which is indicative of the following: geometric layout of the one or more object regions in each of the production layers; and synchronization data for the mold regions and object regions formation in the production layers.

The present disclosure also presents a method for use in additive manufacturing of a metal object. The method comprises: constructing successive production layers, each including a number of mold regions associated with a respective number of object regions, such that each mold region comprises a metal-facing zone having a closed-loop part configured to define a cavity forming the respective object region to receive molten metal therein, wherein the constructing of each production layer is controllably performed in accordance with a predetermined building plan, by carrying out the following: for each production layer, prior to deposition of molten metal material in the number of object regions, creating said number of mold regions, by depositing a mold material in said number of mold regions while varying one or more of mold material deposition parameters and conditions within at least the metal-facing zones of the mold regions, to thereby form in the mold region a predetermined arrangement of spaced-apart sites of relatively weak mechanical properties relative to spaces between said sites within said mold region, said arrangement of the spaced-apart sites being selected in accordance with properties of the metal object and molten metal deposition process.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A schematically illustrates, by way of a block diagram, the additive mold construction system of the present invention—in conjunction with an object fabrication system;

FIG. 1B more specifically exemplifies the configuration and operation of the mold construction system of the present invention in conjunction with an object fabrication system;

FIG. 2A schematically illustrates, by way of a flow diagram, the additive mold construction method according to the present invention implemented for additive metal casting;

FIGS. 2B to 2F illustrate the principles of the mechanism utilized in the invention for the additive mold construction, wherein FIG. 2B shows typical stress-strain curves of ceramics, metals and polymers; FIG. 2C shows a stress-strain curve of a brittle material under tensile and compressive stresses; FIG. 2D shows a stress-strain curve of a ceramic material more resistant to compression than to tensile stress; FIG. 2E is a schematic diagram showing the pressure exerted by molten metal on the mold wall and the consequent stresses developing within the mold wall; and FIG. 2F shows schematically stress-strain curves corresponding, respectively, to strong, tough and ductile materials;

FIGS. 3A to 3D schematically illustrate the main principles of the invention for configuring the mold region including a metal-facing zone formed with the arrangement of spaced-apart relatively weak sites being a single-part zone (FIG. 3A) or two-part zone (FIG. 3B), and additionally formed with a metal-nonadjacent zone (FIGS. 3C and 3D);

FIGS. 4A-4B and FIGS. 4C-4D show two exemplary mold regions, respectively, manufactured according to some embodiments of the invention and having predetermined arrangements of spaced-apart sites of relatively weak mechanical properties relative to spaces between said sites, wherein FIGS. 4A-4B exemplify the top view and perspective view of the mold regions having non-uniform thickness along the perimeter due to the pattern of inner surface of the ring-shape mold region (e.g. metal-facing zone thereof), and FIGS. 4C to 4D exemplify the top view (FIG. 4C) and perspective view (FIG. 4D) of the mold regions and mold structures (or parts thereof) having non-uniform thickness along the perimeter due to the pattern of outer surface of the mold (e.g. metal-facing zone thereof);

FIGS. 5A and 5B show top and perspective views, respectively, of an exemplary mold region (or mold structure or a part thereof) having predetermined arrangements of spaced-apart sites of relatively weak mechanical properties relative to spaces between said sites, where such sites are formed by air-filled spaced-apart gaps along the mold (e.g., metal-facing zone thereof);

FIGS. 6A to 6F show two exemplary molds structures (or parts of mold structures), having predetermined arrangements of spaced-apart sites of relatively weak mechanical properties relative to spaces between said sites, where such sites are filled with a mold material of a material composition providing relatively high compressibility as compared to the rest of the mold structure, wherein FIG. 6A shows the perspective view of the first exemplary mold structure and FIGS. 6B and 6C show cross-sections taken at different heights of said first mold structure; and FIGS. 6D to 6F show, respectively, the perspective view of the second mold structure and two cross-sectional views at different heights thereof;

FIGS. 7A to 7E show several exemplary molds structures and mold regions, having predetermined arrangements of spaced-apart sites of relatively weak mechanical properties relative to spaces between said sites, and each mold structure further includes an array of supporting fins arranged in a spaced-apart relationship along an outer surface of the mold structure (e.g. metal-facing zone thereof); wherein:

FIGS. 7A to 7B show, respectively, the top view and a perspective view of the exemplary mold structure in which the relatively weak sites are implemented as in the example of FIGS. 5A-5B and the supporting fins have substantially rectangular cross section;

FIG. 7C shows the top view of another exemplary mold structure in which the relatively weak sites are configured as in the example of FIGS. 6A-6F and in which the fins are spaced-apart from the outer surface of the mold structure;

FIGS. 7D and 7E show the top view and perspective view of an exemplary mold structure, in which the relatively weak sites are configured as in the example of FIG. 7C but the supporting fins are constructed as protrusions from the outer surface of the mold structure and have a triangular cross section along the lateral dimensions;

FIGS. 8A to 8H show further exemplary mold regions and/or mold structures, having predetermined arrangements of spaced-apart sites of relatively weak mechanical properties relative to spaces between said sites, where each mold structure includes metal-nonadjacent zone which is spaced-apart from the metal-facing zone by an air gap; wherein:

FIGS. 8A to 8C show, respectively, the top view of a mold region or mold structure, perspective view of a mold region or mold structure, and photo of an exemplary mold structure with the respective metal structure in which the proximate wall (i.e., metal-facing zone) is configured similar to the example of FIGS. 4C and 4D;

FIGS. 8D and 8E show, respectively, the top view of a mold region or mold structure, and perspective view of an exemplary mold structure in which the proximate wall is configured similar to example of FIGS. 5A and 5B;

FIGS. 8F and 8G show, respectively, the top and perspective view of an exemplary mold region or mold structure in which the proximate wall is configured similar to example of FIGS. 6A to 6F; and

FIG. 8H shows the top view of an exemplary mold structure where the proximate wall is configured similar to example of FIGS. 7A to 7B;

FIG. 9 shows yet another example of a mold region or mold structure according to embodiments of the disclosure in which the metal-facing zone of the mold region is configured as in example of FIGS. 4C and 4D and where the metal-nonadjacent zone comprises two adjacent sub-zones differently spaced from the metal-facing zone, where one of the sub-zones is configured as in example of FIGS. 5A-5B;

FIGS. 10A to 10D show three exemplary mold regions/mold structures manufactured according to some embodiments of the invention where the metal-nonadjacent zone includes two subzones, in which the sub-zone directly interfacing with the metal-facing zone is configured as a compressible filler; and

FIGS. 11A and 11B exemplify a part of the metal object surrounded by the mold structure (FIG. 11A) resulting from the construction method according to the invention; and the metal object part with the mold structure being partially removed (FIG. 11B).

### DETAILED DESCRIPTION OF EMBODIMENTS

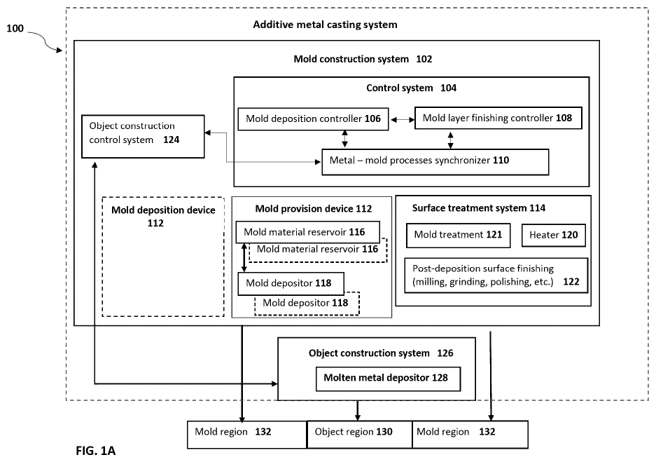

Reference is made to FIG. 1A which schematically illustrates, by way of a block diagram, a mold construction system 102 configured and operable according to the technique of the present disclosure. The mold construction system 102 is typically a part of an additive metal casting system 100 which also includes an object construction system 126.

It is to be understood that the construction and operation of the object construction device 126 do not form part of the present disclosure and therefore are not described herein in details, except to note the following: The operation of the mold construction system 102 to layer-by-layer form the mold is properly synchronized with operational cycles of the object construction device 126 (via communication with an object construction control system 124) to additively create production layers, each including metal in an object region 130 surrounded by a mold region 132. It should be understood that the object design defines the number of object regions surrounded by the respective mold regions.

The object construction device is preferably configured and operable as described in the above-mentioned US20200206810, and/or in U.S. patent application Ser. Nos. 17/744,686, 17/748,069, assigned to the assignee of the present application, which are incorporated herein by reference with respect to specific not limiting examples of the object construction device and its associated object construction control system 124.

The mold construction system 102 includes inter alia a control system 104 controlling the operation of one or more mold provision devices 112 and a surface treatment system 114. The control system 104 is a computerized system including inter alia a mold deposition controller 106, a mold layer finishing controller 108, and a metal-mold processes synchronizer circuit 110. The latter is in data communication with the object construction control system 124.

The one or more mold provision devices 112 are controllably operable to deposit mold material to form the mold region 132 defining the object region 130 in a production layer. The object region 130 is configured to receive molten metal being deposited by a molten metal depositor 128.

The mold provision device 112 is configured and operable by the mold deposition controller 106, in accordance with a predetermined building plan of successive formation of multiple production layers. The mold provision device 112 is configured to vary one or more of mold material deposition parameters to thereby create, in at least a metal-facing zone of the mold region, an arrangement of the spaced-apart sites of relatively weak mechanical properties as compared to spaces between these sites within the mold region. The arrangement of the spaced-apart sites is previously selected in accordance with properties of the metal object and molten metal deposition process.

It should be noted that the principles of the present disclosure for construction of each mold region in each production layer (and thus the entire mold structure) can be performed using both in-situ and ex-situ construction process. In the in-situ process, the mold region(s) of each production layer is/are constructed within the common working area with the object region(s) of the same production layer, and the mold material being deposited is in a green-body state. This process requires proper adhering between the mold regions of neighboring (successively produced) production layers, which require proper control of the mold material properties and surface treatment of each deposited mold region. For example, the in-situ process may utilize deposition of ceramic-based green-state paste. In another example, the in-situ process may utilize a binder jetting procedure, i.e., using a mold powder provision device, a mold binder dispensing device and a mold powder removal device.

In the ex-situ process, the mold unit forming the mold region is constructed in a separate working area and is brought to the working area adjacent to that of the object region by a separate holding/translating unit (e.g., robot). For example, the ex-situ process may utilize a binder jetting procedure, i.e., using a mold powder provision device, a mold binder dispensing device and a mold powder removal device. In another example, the ex-situ process may utilize a stack of frames, each containing a sand-based mold region with or without a replaceable pattern.

In the description below, the technique of the present disclosure is exemplified in relation to the in-situ mold construction utilizing ceramic-based green state paste. However, it should be understood that the principles of the technique of the present disclosure are not limited to this mode of implementation.

As will be described more specifically further below, the mold region may be designed as a single-zone or multi-zone mold region, thus including at least a metal-facing zone including/embedding the arrangement of the spaced-apart sites of relatively weak mechanical properties as compared to spaces between these sites within the metal-facing zone. The metal-facing zone is configured to define a closed-loop cavity forming the associated object region. In some embodiments, the metal-facing zone is a two-part zone enclosing the cavity therebetween.

Considering the multi-zone design of the mold region, the mold region may include a metal-nonadjacent zone which is located adjacent to the metal-facing zone (either directly or via an air gap between them). In some embodiments, at least the metal-nonadjacent zone includes two or more sub-zones of different mechanical properties. This will be described more specifically further below.

In the description below, the zones and sub-zones are at times referred to as “walls”. Thus, the mold region may be a single-wall region, where such single wall constitutes the metal-facing zone and is termed “proximate wall” with respect to its location interfacing with the object region. The proximate wall is configured to define the cavity forming the object region. In the multi-zone configuration of the mold region, the metal-nonadjacent zone is configured as a single-wall or multi-wall structure, where such walls constitute sub-zones of the metal-nonadjacent zone. The walls (sub-zones) of the metal-nonadjacent zone are referred to hereinbelow as “external wall” and “intermediate wall”.

The sites of the relatively weak mechanical properties of the mold region are created by mold depositor(s) 118 during the mold deposition, according to the predetermined building plan. This can be implemented by one or more of the following: creating spaces/notches in the wall(s), bubbles/pores formation in the wall(s), variable thickness of the wall(s), sites of different density of the mold material, and sites produced by a different material composition of the mold material. The different density of mold material being deposited in the selected sites may be achieved by controllably varying the duration of deposition, rate of deposition, and/or amount of mold material. Furthermore, at least one of the compositions of the mold material, concentration of the material, mechanical and rheological properties of the mold material may be varied, while using the same deposition method.

Each mold provision device 112 may include one or more mold material reservoirs 116 connected via feeding line(s) to one or more traveling mold depositors 118. Each mold depositor 118 is driven (by a suitable drive mechanism which is not specifically shown) for movement in a horizontal plane along a predetermined trajectory according to the deposition plan.

The mold depositor 118 may be of any known suitable configuration, which does not form part of the present disclosure. Such mold depositor is typically in the form of one or more extruders or deposition heads, and each is in fluid communication with the one or more mold material reservoirs 116. It should be noted, although not specifically shown, that since the mold material is typically a relatively viscous material, the mold provision device 112 (e.g., traveling mold depositor(s) 118 and/or the feeding line(s)) typically includes stirrers and/or tubing and/or tubing loop configured to perform continuous circulation of the mold material which is not currently involved in deposition process.

According to some embodiments of the present disclosure, mold materials include mold materials in paste form, powder form, granular form, slurry form, and mold materials mixed with binders, releasing agents, activating agents, UV absorbing particles, crosslinking agents, heat-absorbing particles, or other additives to facilitate mold fabrication and use. According to embodiments of the present disclosure, mold materials include, but are not limited to ceramics (e.g., zirconia, alumina, magnesia, etc.), sand, clay, metallic powders, and any combination thereof.

In the description below, the mold material is at times termed as ceramic-based material, but it should be understood that the principles of the present disclosure are not limited to this specific example, as well as not limited to any type of mold material. The properties of the mold material being used are taken into account, together with those of the metallic material and the building plan, to design the preferred arrangement of the spaced-apart relatively weak sites as well as to select the optimal number of walls in the mold region.

In some embodiments, two material reservoirs 116 may be used for ceramic-based material. The use of two reservoirs may be favorable to make the mold construction process more efficient in time, when a large reservoir, which may be positioned remotely from the production area, is configured in advance to provide proper wetting for a large amount of ceramic-based material (which requires time) under constant mixing. This large reservoir may be in fluid communication (by pipes) with a smaller reservoir, which is also kept under constant mixing, wherein the smaller reservoir is in connection with the mold depositor 118 and possibly also moved together with the mold depositor 118 on the build table to form the predetermined mold regions 132.

It is noted that in some embodiments, for example where the mold material is in a powder form, the mold provision device 112 may include additional mold depositor(s)/dispenser(s) to successively perform mold material deposition and dispense one or more special binding agents in selected regions via binder jetting process. This process is followed by removal of the mold powder from sites outside these regions, thus forming the arrangement of the relatively weak sites outside the regions containing the binding material.

The mold construction system 102 may further include a surface treatment system 114. The surface treatment system is configured and operable to apply one or more surface treatments to the mold material in the mold region and may include one or more heaters 120; mold treatment device(s) 121, and a post-deposition surface finishing system 122.

The heater 120 is operable to apply temperature treatment to the mold material in the mold region to harden the mold material, and in some embodiments, may be configurable to apply the temperature treatment to the mold region after each of one or more mold deposition iterations.

In some embodiments, heater 120 may be realized as a common system that provides heating to one or more of the object construction system 126 or part thereof, a building table (not shown), and a production chamber accommodating the mold construction system 102 and object construction system at least during mold construction and object construction, respectively (not shown).

For another example, in embodiments where the mold material is in the powder form, the mold treatment device 121 may include a curing system to cure the mold using any known suitable technique, such as thermal curing, UV curing, gas curing, etc. Other mold treatments that might be suitable to be used in the mold creation may include any one of the following: microwave irradiation, UV irradiation, arc-jet, laser irradiation, ultrasonic vibration, vacuum drying, chemical agent treatment, exposure to electromagnetic field, exposure to a gaseous atmosphere, and any combination thereof.

The post-deposition surface finishing system 122 may be configured to perform mechanical surface treatment of at least a portion of the mold region, or on surfaces of the mold region facing the object region, e.g., milling, grinding and/or polishing.

It should be noted that mold post-deposition surface finishing is not limited to mechanical surface treatment. Several mold post-deposition surface treatments may be applicable to any portion of the mold region (i.e., not only to the metal-facing wall of the metal-facing zone): hardening using e.g., UV light, smoothing using e.g., laser induced melting and others, as described below with reference to FIG. 1B.

Reference is made to FIG. 1B showing more specifically the exemplary configuration and operation of the above-described mold construction system 102 according to embodiments of the present disclosure. In the figure, a cross section view of a part of an object-and-mold structure 205 is shown, which is formed by several successively deposited production layers 202-0 to 202-4.

The structure 205 includes a metal object 206 within (enclosed by) its mold structure which is in the process of being additively cast on a build table 210. The build table is configured to be placed in a temperature-controlled environment (not shown here). Relative movement is provided between the build table 210 and elements of a production system (e.g., mold depositor 118 and metal deposition device which is not shown here) used for the fabrication of the production layers.

The relative movement may be provided on command from the control system 104 (or control system 124 associated with the metal deposition process) and can be realized side-to-side (in an x-direction 224), front-to-back (in a y-direction), as well as up and down (in a z-direction 220), and possibly also rotated clockwise and counterclockwise 222 with respect to a coordinate system 230. Typically, for casting large, unwieldy, and heavy objects, the displacement of the build table 220 may be limited to relative movement in the z-direction.

In some embodiments, the build table 220 is moved along the z-direction between the production layers in order to keep a working distance between the material depositor(s) and the surface of the working area. In some embodiments, the build table 220 is moved after the construction of the mold region and the production of the object region of the current production layer, before the deposition of the mold region of the next production layer. In some embodiments, the x-y relative motion may be accomplished by moving the mold depositor(s) 118, the heater(s) 120, and the mechanical surface treatment unit(s) 122 while keeping the build table 210 stationary.

The additive casting of the technique of the present disclosure proceeds in accordance with a predetermined building plan of successive formation of multiple production layers (202-0 to 202-4). In the non-limiting example shown in FIG. 1B, in production layers 202-0 to 202-3 both the mold construction and the metal casting are accomplished, whereas in the current production layer (202-4) molten metal 212 is being deposited after the mold region 204-4 of the current production layer—defining object region 208—was fabricated. Typically, one or more bottom production layers (e.g., 202-0) are dedicated to mold material forming the lower surface for the successive production layers.

In this specific not limiting example, layers 202-0 to 202-4 include mold regions 204-0 to 204-4, wherein the bottom layer 204-0 serves as the base layer, and the successive production layers (204-1, 204-2, 204-3, and 204-4) include the mold regions defining mold cavities forming the object regions for receiving molten metal. The mold regions 204-0 to 204-4 of layers 202-0 to 202-4 are shown with dotted lines representing the interfacing surfaces between them. This is to indicate that the mold regions of the production layers were fabricated at different production cycles and are in tight contact and adhere one to another.

As also shown in the figure, the mold construction system 102 includes the control system 104, mold provision device 112 including mold material reservoirs 116 and mold depositors 118 receiving mold material from the reservoirs 116, and additional mold fabrication devices, e.g., a heater 120 and mechanical surface treatment devices 122.

The principal operation of the mold region fabrication is carried out iteratively within the current production layer, on one or more locations (single location being shown in the example of FIG. 1B), by (sequentially) traveling the provision device 112 over the build table 210 and additively dispensing the mold material(s) to form the mold region (e.g., 204-4) under the control of the mold deposition controller 106. In some embodiments, post-deposition treatments (e.g., mold layer hardening, inner surface treatment, e.g., milling, grinding, polishing) are performed under the control of the mold layer finishing controller 108, as described above.

The casting system 100 also includes an object construction system 126, which, as shown in FIGS. 1A and 1B, includes a molten metal depositor 128. A relative displacement between the molten metal depositor and the build table 210 may be provided, e.g., the molten metal depositor may be movable. The molten metal depositor 128 may include crucibles, remote molten metal reservoirs, wire or rod stock for melting, powder for melting or combinations thereof.

It should be noted, although not specifically shown, that the object construction system 126 also includes its controller (which is a part of or operates in communication with the control system 104 of the mold construction system 102), as well as surface treatment device(s) including one or more movable heaters (performing pre-heating and post-heating of the object region). Generally, during additive casting processes, the movable units are driven for movements in the x-y plane as well as in the z direction, and have degrees of freedom in horizontal motion, vertical motion, and rotation.

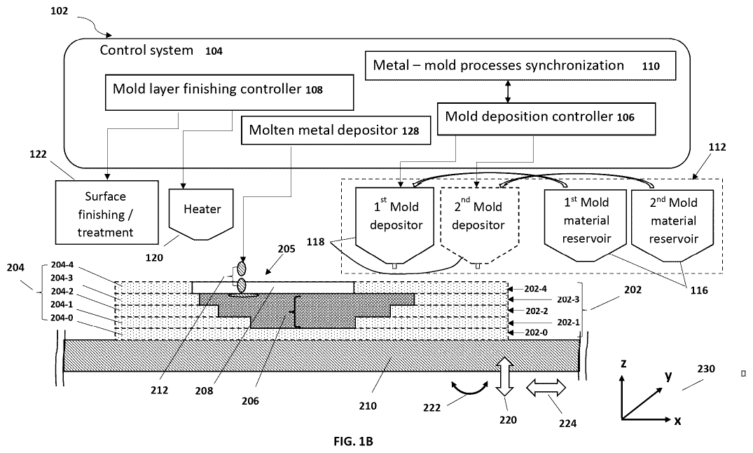

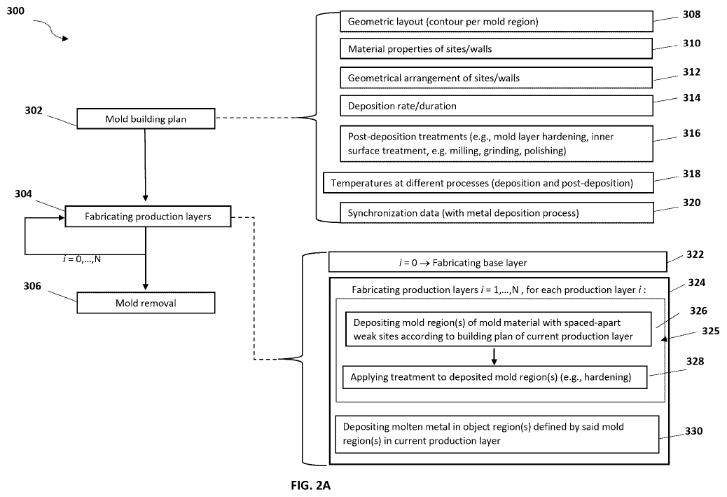

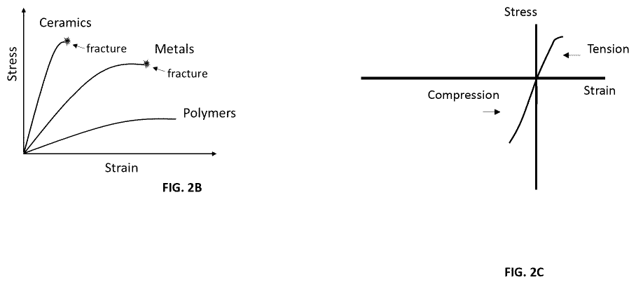

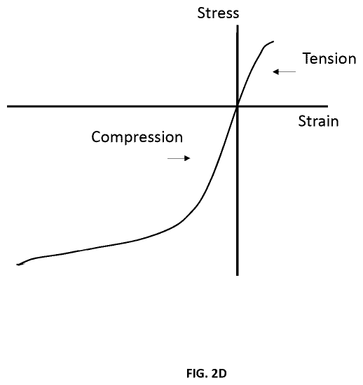

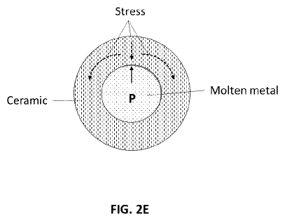

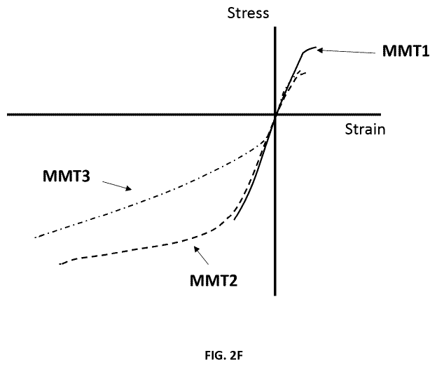

Reference is made to FIG. 2A which schematically illustrates, by way of a flow diagram 300, an additive mold construction method according to embodiments of the present disclosure providing the mold region configured as described above, i.e., comprising the predetermined arrangement of spaced-apart sites of relatively weak mechanical properties relative to spaces between said sites within the mold material. This arrangement is selected in accordance with properties of the metal object to be created and molten metal deposition used for creation of such object.

The method includes iteratively fabricating, based on a mold and object building plans 302, a set of vertically stacked production layers (i=0, . . . , N) one upon another (step 304), which, once the final production layer is completed, form the entire cast mold structure surrounding the metal object. The mold structure is then removed (step 306).

The mold building plan 302 includes the necessary information/parameters to allow successive formation of multiple production layers, and for each production layer, formation of one or more mold deposition iterations in each mold region associated with a respective object region. Such mold deposition of the mold region (e.g., via iterations) may be completely performed prior to depositing the molten metal to form the respective object region of the current production layer.

In particular, the mold building plan 302 includes geometric data indicative of the geometry/shape of the metal-facing zone of the mold region 308, i.e., contour per metal-facing zone determined by the required finished surface of the metal object region; and parameters (geometrical and material parameters) of the arrangement of spaced-apart relative weak sites as well as geometric layout of the mold region structure 312 (e.g., the number of walls/zones, arrangement of walls/zones).

In some embodiments, the sites of relatively weak mechanical properties (further denoted “weak sites”) may be located in positions where relatively higher pressure exerted by the heated metal is expected due to the shape of the metal object.

For example, the arrangement may be such that the ratio between the width of the weak site and the width of the space between the weak sites within the mold region ranges from about 1:5 to about 1:100 (or from about 1:10 to about 1:50). It should be understood that width of the weak site and space between neighboring weak sites is the dimension along the perimeter of the metal-facing/metal-nonadjacent zone.

The material-related data 310 of the mold building plan 302 includes the properties of one or more materials used in the formation of the metal-facing and metal nonadjacent zones of each mold region (e.g., properties and material compositions of the various sites and walls of the mold). For example, the variable material property of the mold may be associated with porosity. In this example, the formation of the weak sites may be accomplished by introducing gas (e.g., bubbling) into the mold material at selected sites in the mold region, thereby making it locally more porous and therefore having weaker mechanical properties as compared to the surroundings of said sites in the mold region. Additionally, or alternatively, porosity in the weak sites of the mold may be achieved by treating these sites by a chemical agent. Applicable chemical agents may be foaming agents (SDS—Sodium Dodecyl Sulphate and Calcium Carbonate as an example).

It should be noted that sacrificial chemicals being decomposed, e.g., in response to heating, would leave open pores. Radiation-responsive materials may be used, so that in response to locally applied appropriate electromagnetic radiation the materials become either mechanically weakened or mechanically strengthened. In the latter case, the non-irradiated locations are left non-strengthened and thus relatively weaker than the radiated ones.

In some other examples, the formation of weak sites in the mold region may be accomplished by selectively depositing in these sites a material composition of the mold material which is more compressible than the material composition of the remainder of the mold region (or respective wall of the mold region). Different compressibility may be achieved, for example, by varying the amount of binders in a compressible material such as a porous ceramics. Different compressibility is aimed at reducing the tensile strength of the mold region as well as the entire mold structure at the sites with the more compressible material, thereby providing a breathing mode defined above.

Further, the mold building plan 302 includes data indicative of the mold deposition process to sequentially form multiple production layers. This data includes, for example, a number of mold deposition iterations to create the mold region of each production layer, thickness of the deposited mold material, viscosity of the mold material, cross-section shape (rounded, square, etc.).

Typically, the building plan also includes rates and durations of the mold material deposition 314.

In some embodiments, as will be described below, the weak sites in the mold region walls may be in the form of notches within the mold region wall. Such notches may be formed by varying at least one of: the duration of the deposition, the amount of the mold material and the rate of deposition, such that less amount of mold material is being deposited in the weak sites (as compared to their surroundings), reducing thereby the tensile strength of the mold region in the weak sites.

The building plan may also include data indicative of the temperature parameters and conditions of one or more post-deposition treatments 316. The post-deposition treatment(s) may be of the type aimed at mold hardening (e.g., by heating), surface treatment, in particular inner surface of the mold region by which it faces the object region (e.g., by milling, grinding and/or polishing).

Further, typically included in the building plan is data indicative of the temperature parameters/conditions at different processes 318 (including the mold deposition process and post-deposition treatment(s)). These include, for example, the temperatures, pressure and environmental conditions (gas composition) of material reservoir(s), the mold provision devices, and the build table during the mold deposition, and the temperature right after the mold deposition.

It should be noted that the mold deposition and metal deposition used for creation of the mold region and object region, respectively, are successively performed during creation of each production layer and have different process parameters and timing. Therefore, the building plan includes or defines synchronization data to properly synchronize the mold deposition procedure with the metal deposition process 320, which is critical for the additive mold and object casting.

Thus, generally, the building plan data includes data indicative of two or more of the following: geometric layout of the object region(s) in each of the production layers; material, geometrical properties and arrangement of the metal-facing and metal-nonadjacent zones of each mold region in each production layer; mold deposition process parameters; surface treatment parameters and conditions of surface treatment of the mold region; and synchronization data for the mold regions and object regions formation in the production layers.

Typically, the fabrication of the production layers may start with the fabrication of a base layer (i=0) on a build table 210 (e.g., mold production layer 202-0 in FIG. 1B) step 322. The stage 324 of fabrication of each successive production layer (i=1, . . . , N) includes the mold region creation 325 which begins with depositing mold region(s) of mold material while creating the arrangement of spaced-apart weak sites according to the building plan of the current production layer (step 326) which may include multiple deposition-iterative procedures; and successively applying post-deposition treatment(s) to each deposited mold region (e.g., milling, polishing, hardening) (step 328). This is followed, in a synchronized manner, by the molten metal deposition in each respective object region defined by the mold region (its metal-facing zone) in the current production layer (step 330).

It should be noted that in some embodiments, an additional post-treatment is used including at least partial surface finishing of the deposited mold region(s) of the production layer (step 328). This is in some embodiments performed before the mold region is cured or hardened, whereas in some other embodiments such surface finishing is performed after the mold region is hardened.

Reference is now made to FIGS. 2B to 2F supporting the explanations and associated terms used herein underlying the principles of the technique of the present disclosure. FIG. 2B illustrates typical tensile/compressive stress-strain curves for three classes of materials, ceramics (typically used for mold creation), metals (used for object creation), and polymers that can be used in the mold material(s). Stress-strain curves visually display the material's deformation in response to a tensile, compressive, or torsional load. The stress strain curve for a ceramic material is almost straight line up to a yield point, both under tensile or compressive stresses, soon after which the ceramic suddenly reaches the fracture point and breaks. Metals are ductile materials, exhibiting plastic deformation (during the flattened part of the curve) before fracture, whereas ceramics exhibit negligible plastic deformation under external loading (hardly any flattened part in the stress-strain curve in FIG. 2B). This property of ceramic materials justifies their definition as brittle (opposite of ductile) materials. FIG. 2C shows a representative (qualitative) stress-strain curve of a brittle material under tensile and compressive stresses where the opposite signs of the strains under tensile/compressive stresses are clearly indicated.

Though, ceramics, being brittle materials, have compressive strengths about ten times higher than their tensile strength (defined as the maximum stress in the stress-strain diagram of tension/compression). The discrepancy between tensile and compressive strengths is in part due to the brittle nature of ceramics. When subjected to a tensile load, ceramics, unlike metals, are unable to yield and relieve the stress. The tensile strength of ceramics (as well as glasses) is low because the existing flaws (internal or surface cracks) act as stress concentrators and do not propagate under compression, resulting in a tendency of a material to fracture/crack with very little or no detectable plastic deformation beforehand. In compression, however, the flaws in the ceramic material do not cause stress concentrations or crack propagation, as they do in tension. For example, under a compressive load a transverse crack in a ceramic material may tend to close up and so cannot propagate.

The use of ceramics or ceramics-based materials as the mold material during metal casting is justified by their extremely high stiffness, i.e., their very high modulus of elasticity (Young's modulus) in addition to their ability to withstand the high temperatures of molten metals (for example, 1100 to 1300 degrees Celsius for gray iron).

The ceramic-based mold fabricated according to the principles of the technique of the present disclosure (i.e., including spaced-apart weak sites inducing “breathing mode”) is particularly suitable for use in additive metal casting, which involves multiple iterations of molten metal deposition, as well as multiple rounds of heating the solidified metal casting prior to depositing the next metal layer. As shown in FIG. 2E, in such a process, the previously solidified metal casting unavoidably expands during heating, thereby exerting pressure P on the mold region from inside, in addition to the pressure exerted by a portion of the molten metal during casting of the successive production layer. It is important to note that due to the axial compressive stresses being developed inside the ceramic mold region due to the molten metal, with no relief, circumferential tensile stresses develop inside the ceramic mold region all along the mold perimeter.

The ability of a material to deform plastically and to absorb energy in the process before fracture are termed toughness and compressibility. The emphasis of this definitions should be placed on the ability to absorb energy before fracture. It should be noted that ductility is a measure of how much something deforms plastically before fracture, but just because a material is ductile does not make it tough. The key to toughness is a good combination of strength (tensile/compressive) and ductility. A material with high strength (tensile/compressive) and high ductility has higher toughness than a material with low strength and high ductility. FIG. 2D shows an example of a stress-strain curve of a ceramic material which is more resistant to compressive stress (has higher toughness) than to tensile stress. This can be judged by its high compressibility under compressive stress. Young's modulus measures a material's rigidity. The more rigid the material, the higher its modulus of elasticity. A material is considered to exhibit brittle fracture if its behavior is elastic virtually up to failure. Young's modulus does not depend on faults (microcracks) in the material. Toughness, on the other hand, is a measure of a material's resistance to crack propagation. Unlike mechanical strength, toughness is independent of fracture-initiating flaws (microcracks), though it depends on the microstructure of the material.

In order to be tough, a material must be both strong and ductile. Therefore, one way to measure toughness is by calculating the area under the stress strain curve from a tensile test. The area under the stress strain curve is called “material toughness” and it has units of energy per volume. Material toughness equates to a slow absorption of energy by the material. Toughness tends to be small for brittle materials, because elastic and plastic deformations allow materials to absorb large amounts of energy. Thus, brittle materials, when subjected to stress, break with little elastic deformation and without significant plastic deformation. Brittle materials absorb relatively little energy prior to fracture, even those of high strength.

FIG. 2F shows strain-stress curves of mold material types, MMT1, MMT2, and MMT3, which differ from one another by their mechanical properties, in particular their tensile strength TS, toughness TH, and compressibility C. The first-type mold material, MMT1, is the strongest/stiffest of the three, characterized by highest tensile strength TS₁ and highest modulus of elasticity. It has the lowest toughness TH₁ and nearly zero (minimal) compressibility C₁ as can be judged from the lack of plasticity at the yield point under compressive stress. The second-type mold material, MMT2, has lower tensile strength TS₂ as compared to material MMT1 (TS₂<TS₁), but higher toughness TH₂ as compared to MMT1 (TH₂>TH₁). Material MMT2 has significantly higher compressibility C₂ than material MMT1 (C₂>>C₁), and notably, MMT2 has both an elastic regime where the compressibility C₂ is reversible (in the linear part of the strain-stress curve) and a plastic regime where the compressibility C₂ is mostly irreversible. The third-type mold material, MMT3 has about the same toughness TH₃ as material MMT2 (TH₃≈TH₂) as judged from the similar area under the strain-stress curves. However, the compressibility C₃ of material MMT3 is mostly irreversible, as judged from the non-linear shape of the strain-stress curve.

The mold structure for additive casting is manufactured by an additive deposition of mold material e.g., ceramic-based material in mold region(s) of a successive production layer, after depositing molten metal into object region(s) of the preceding layer. The object regions are formed by metal deposition in cavity(ies) formed by previously deposited mold material of the preceding layer. Formation of the successive mold region(s) in the successive production layer, for example on top of the previous mold region(s) of the preceding production layer, includes deposition of the green-state mold material (e.g., viscous paste) on top of a baked mold material (of the preceding layer) that had undergone heating by molten metal in the respective cavity (the corresponding object region) and optionally cooling during a cooldown period.

Thus, the mold structure for additive casting may exhibit cracks. The cracks may occur in a mold region during the construction of that mold region. The cracks may appear in previously constructed mold region(s) of the preceding production layers—or that/those in several consecutive production layers, in response to the deposition of molten metal in the currently fabricated production layer. Mold structure cracks may sometimes be severe such that the deposited molten metal breaches the mold structure. If severe mold structure breaches are exhibited, the additive metal casting cannot be completed, or the resulted metal object is defected.

The mold regions (as well as the entire mold structure) being fabricated by the technique of the present disclosure is configured to withstand the pressure exerted during metal casting and preserve the integrity of the mold structure by significantly decreasing the number and sizes of cracks that can be formed within the mold structure by the action of the pressure exerted by the molten metal.

The inventors have shown that by designing a controllably weakened single-wall mold structure or proximate wall of the multi-wall mold structure, they succeeded to introduce a “breathing mode” of the mold structure which, on one hand, might cause a local, metal-induced, collapse of the mold structure, but even in such worst-case scenario, this would be a local event while preventing a severe crack of the mold structure and avoiding (or reducing) production failures.

The following are specific not limiting examples of the mold region configurations, all configured according to the present disclosure, i.e., having predetermined arrangements of spaced-apart sites of relatively weak mechanical properties relative to spaces between said sites. To facilitate understanding, the same reference numbers are used to identify components/elements common in all the examples.

The figures show top views and perspective views of the mold regions/structures. It should be understood that the top view of the mold structure actually corresponds to a cross-sectional view and thus illustrates also the mold region in a specific production layer; the perspective view may also correspond to that of the mold region in the production layer or to the entire mold structure. Hence, for simplicity of illustration, at times the same reference number is used for the mold region/structure in the top view and perspective view.

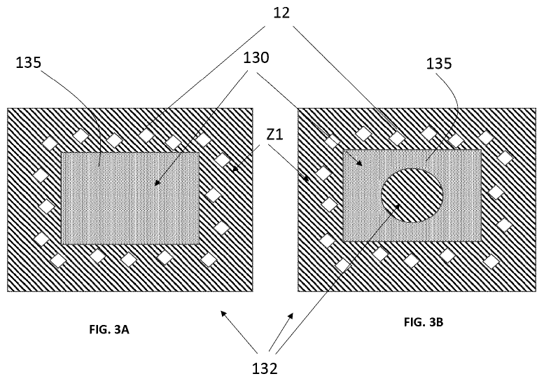

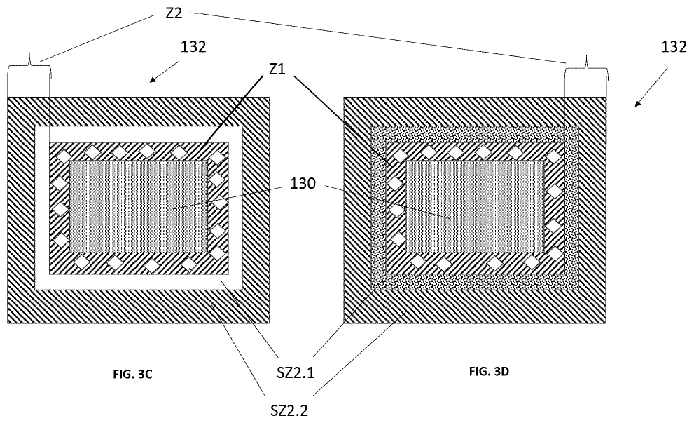

Reference is made to FIGS. 3A-3D schematically illustrating the main principles of mold region configuration according to the present disclosure. As shown, the mold region 132 defines a closed-loop cavity 135 forming the object region 130. The mold region 132 has at least one zone Z1 being a metal-facing zone including the arrangement of spaced-apart relatively weak sites 12. In the example of FIG. 3B, in which the object region 130 is a ring-like (toroidal like) region, the metal-facing zone Z1 is a two-part zone including an insert part and a closed-loop part such that they define together the ring-like cavity forming the object region 130.

In the examples of FIGS. 3A and 3B, where the mold region includes only the metal-facing zone Z1 including the arrangement of spaced-apart sites 12, the mold material (in the spaces between the relatively weak sites 12) has mechanical properties of MMT1 material described above, i.e., being as strong as possible, i.e., relatively high tensile strength TS. As for the material or material composition of the weak sites, it can be of MMT2 or MMT3 type (refer to FIG. 2F). Alternatively, the relatively weak sites 12 may be implemented by varying the local porosity of the mold material by introducing gas (e.g., bubbling) into the mold material at selected sites in the mold region, thereby making it locally more porous and therefore having weaker mechanical properties as compared to the surroundings of said sites in the mold region. Additionally, or alternatively, porosity in the weak sites of the mold may be achieved by treating these sites by a chemical agent.

As exemplified in FIGS. 3C and 3D, the mold region 132 may have a multi-zone design, further including a metal-nonadjacent zone Z2 around the metal-facing zone Z1. The metal-nonadjacent zone Z2 may directly interface with the metal-facing zone (FIG. 3D) or may be spaced-apart therefrom by an air gap (FIG. 3C).

As also exemplified in FIGS. 3C and 3D, the metal-non-adjacent zone Z2 may have multiple (at least two) sub-zones (SZs). The locally adjacent (directly interfacing) sub-zones SZ2.1 and SZ2.2 of the metal-nonadjacent zone Z2 have different mechanical properties. In the example of FIG. 3C, the air gap may actually be considered as a sub-zone SZ2.1 of different mechanical properties as compared to the sub-zone SZ2.2. of the metal-nonadjacent zone Z2.

Considering the example of FIG. 3D where three solid-material zones/sub-zones (i.e., zone Z1 and sub-zones SZ2.2 and SZ2.2) are used in the mold region, all these materials or material compositions can be of different mechanical properties, or that of sub-zone SZ2.2 is different from those of Z1 and SZ2.1, or material composition of SZ2.1 is different from that of Z1 and SZ2.2. In all the embodiments, the metal-facing zone Z1 is made of MMT1 material. For example, in the configuration of FIG. 3C, the material of sub-zone SZ2.2 is preferably similar to that of zone Z1 (MMT1 material). In the example of FIG. 3D, the materials of sub-zones SZ2.2 and SZ2.1 are preferably, respectively, of MMT1 type and MMT2 or MMT3 type.

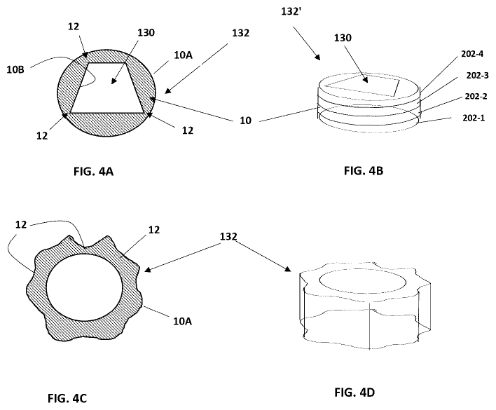

FIGS. 4A to 4D exemplify single-wall (metal-facing zone Z1) mold regions 132, in which the weak sites' arrangement of the mold region(s) is achieved by non-uniform thickness (or width) of the mold region along the circumference (perimeter) thereof.

FIG. 4A shows the top view of the mold region 132 having a single wall (metal-facing zone) 10 in which the non-uniform thickness is implemented keeping a uniform shape and perimeter of the outer surface 10A of the wall 10 while its inner surface 10B (defining the shape of the cavity) is defined by non-uniform shape of the object region 130 (i.e., object to be casted). The weak sites 12 are thus defined by relatively thinner segments of the mold region 132.

FIG. 4B is a perspective view of a mold structure 132′, constructed during successive fabrication of mold regions in production layers 202-1 to 202-4 including also the corresponding object regions (shown as a bulk 130).

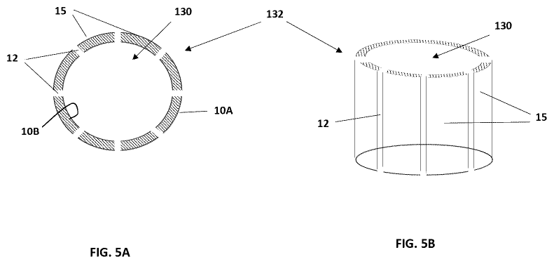

For simplicity, in FIGS. 4A to 4D (and also in FIGS. 5A-5B, 6A-6F, 7A-7E, 8A-8H, 9 and 10A-10D) mold regions in the form of ring-like structures are exemplified. It should, however, be understood that, depending on the shape of the object regions, the mold regions may be in the form of inserts, islands, bridges and the like. For simplicity, in some of the figures described below, the cross section of the inner surface of the mold region facing the respective object region is in the form of a circle, and the resultant mold structure has a cylindrical shape, reflecting a cylindrical-shaped object. The technique of the present disclosure is not limited by the shape, size and additional geometrical characteristics of the object and mold structure.

FIGS. 4C and 4D show the top and perspective views, respectively, of a mold region and corresponding mold structure 132 in which the non-uniform thickness is implemented by surface relief of the outer surface 10A of the mold region. The weak sites 12 are formed by segments of the mold having relatively small width.

FIGS. 5A to 5B show the top and perspective views, respectively, of an exemplary single-wall mold region and corresponding structure 132, in which the spaced-apart weak sites 12 in the mold region are formed with through-going air-filled spaces/gaps, i.e., the mold region 132 is in the form of a patterned design, formed by spaced-apart segments of the mold material spaced by air gaps 12. It should be noted that in cases where the arrangement of spaced-apart sites 12 of relatively weak mechanical properties is implemented by air spaces or notches in the mold region wall, the length (along the mold region perimeter) of the gap (notch) is preferably smaller than about a pre-defined gap (for example, 50 μm for gray iron) in order to avoid leakage of the molten metal through the air gaps (notches) when the molten metal exerts pressure on the mold region wall. Generally, the length of gaps (spaces) 12 is selected (as a part of building plan) in accordance with the surface tension of the molten metal such as to conform with the high enough surface tension and prevent the metal from breaching the mold structure during metal expansion.

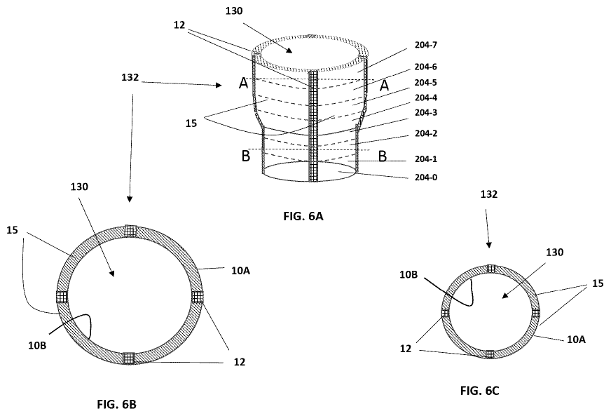

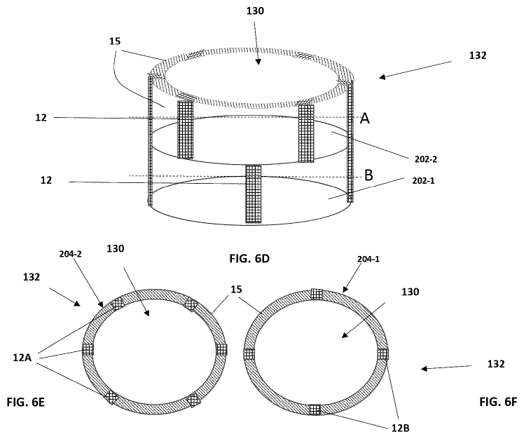

FIGS. 6A-6C and FIGS. 6D-6F exemplify two single-wall mold regions/structures 132, in which the weak sites 12, in the predetermined sites along the mold region wall, are made of a mold material (ceramic-based) of material composition properties providing relatively high compressibility (e.g., MMT2 or MMT3 type material) as compared to the mold material properties of the spaces between these sites (i.e., nearly-zero compressibility).

FIGS. 6A to 6C show the mold region/structure 132 whose cross-sectional dimension (e.g., diameter) varies along the height of the mold region or mold structure (formed by mold regions of successive production layers having different heights from the base layer). This can be seen when the top views of two cross sections of the mold of FIG. 6A are compared: a cross section along AA (FIG. 6C) and a cross section along BB (FIG. 6C). In this non-limiting example, the cross section along BB has a smaller diameter than the cross section along AA. Also, in this example, the arrangement of the spaced-apart weak sites 12 in all the mold regions of the successive production layers 204-1 to 204-7 are aligned.

FIGS. 6D to 6F show the mold structure 132 whose cross-sectional dimension of the successive mold regions (in successive production layers) is the same, and in which the arrangement of the spaced-apart weak sites 12 in the successive mold regions of the successive production layer 202-2 being deposited on top of the mold region of a preceding production layer 202-1 of the mold is laterally shifted with respect to the arrangement of the spaced-apart sites 12 in the preceding mold region of the preceding production layer 202-1.

In addition to the lateral shift described above, in the example of FIGS. 6D to 6F the arrangement of the spaced-apart sites 12 in the mold region of the successive production layer 202-2 being deposited on top of the mold region of the preceding production layer 202-1 is different from the arrangement of the spaced-apart sites 12 in the preceding production layer 202-1. This can be seen by comparing the two respective top views of the mold 132 of FIG. 6D, along AA (FIG. 6E) and along BB (FIG. 6F).

It should be understood that the successive and preceding production layers referred to in these examples are interfacing production layers or a transition region of a change in the arrangement of the weak sites. It should also be noted that the arrangements of the weak sites in different vertical portions of the entire mold structure (or stacks of the mold regions) may be different, e.g., some production layers of the mold portion may be configured as in FIGS. 5A-5B, and some production layers of the other mold portion may be configured as in example of FIGS. 6A-6F.

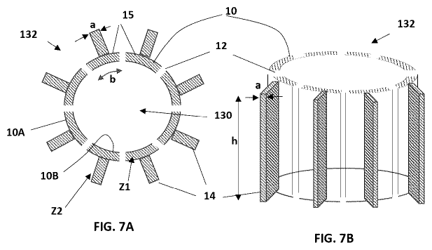

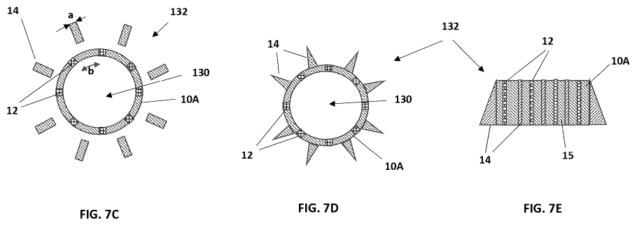

FIGS. 7A to 7E exemplify non-limiting embodiments of mold regions and corresponding structures 132 in which the mold region, in addition to the above-described metal-facing zone Z1/proximate wall 10 including the spaced-apart weak sites 12, includes a metal-nonadjacent zone Z2 which surrounds the zone Z1. In these examples, the metal-nonadjacent zone Z2 is configured as an array of supporting fins 14 arranged in a spaced-apart relationship along at least a portion of the outer surface 10A of the proximate wall 10. Each supporting fin 14 extends in a direction from the outer surface 10A (e.g., in a radial direction in case of circular wall) from a location aligned with a space between the spaced-apart weak sites 12. In this configuration, the weak sites 12 (or at least some of them in said at least portion of the outer surface 10A of the proximate wall 10) are thus located in spaces between the fins 14.

The supporting fins 14 can be made of any suitable material, and preferably the MMT1 type material, being the same or not as that of the MMT1 type material of the metal-facing zone Z1.

The term “supporting fin”, as used herein, refers to any structural element of the mold region that supports the mold region wall, irrespective of whether it is physically connected or not to the outer surface 10A of the mold wall. The supporting fins can assist in protecting the integrity of the mold region wall under the pressure exerted by the heated and/or molten metal.

As shown in the figures, the width a of the supporting fin (dimension along the perimeter of the mold region) is preferably smaller than the respective dimension b of the space between the weak sites in the proximate wall of the mold region. The supporting fins may be of the same height h as the wall of the mold region.

Alternatively, although not specifically shown in the figures, the height h of the supporting fins can be smaller or greater than that of the mold wall. Considering the entire multi-layer mold structure, the supporting fins may for example be provided such that they support only a certain portion of the multiple layers of the mold structure wall. The supporting fins can have any shape suitable for supporting the wall of the mold region, such as but not limited to, rectangular, triangular, or trapezoid. The supporting fins can have a uniform or non-uniform thickness along their height or width.

FIGS. 7A and 7B show, respectively, the top and perspective view of a mold region and corresponding structure 132 where the supporting fins 14 have a rectangular cross section. The supporting fins 14 are formed as projections from the outer surface 10A of the proximate wall being in physical contact with the outer surface 10A.

FIG. 7C exemplifies a top view of a mold region 132 where the supporting fins 14 are spaced from the outer surface 10A of the proximate wall. Also in this non-limiting example, the fins 14 have substantially rectangular cross section. The space (gap) between the proximate wall and the fins 14 provides additional flexibility during possible expansion of the mold structure under the exerted pressure during metal expansion.

FIG. 7D exemplifies a top view of a mold region 132 in which the supporting fins 14 are constructed as protrusions from the outer surface 10A of the proximate wall as in the example of FIGS. 6A-6C but have a triangular cross section along the lateral dimensions such that the supporting fins interface with the wall surface by their base.

FIG. 7E shows a side view of a mold structure 132 in which the supporting fins 14 are protrusions from the outer surface 10A of the wall 10 being arranged between the weak sites 12 and having a triangular cross section along the vertical dimension such that they interface the surface 10A by their top facets.

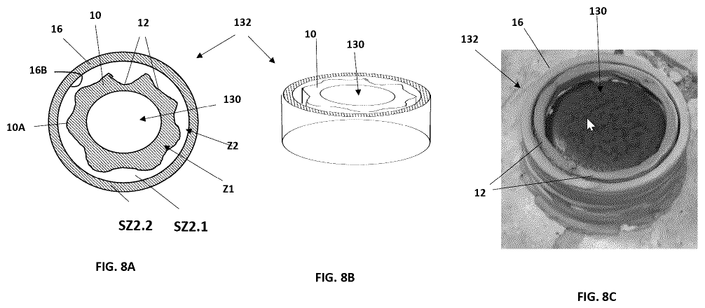

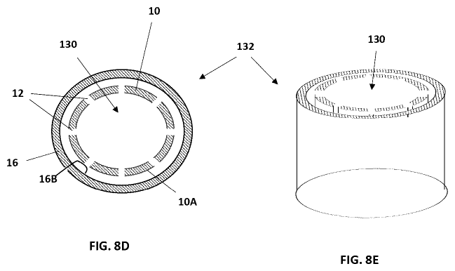

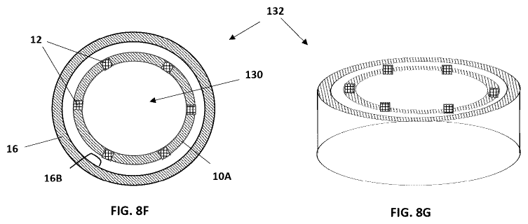

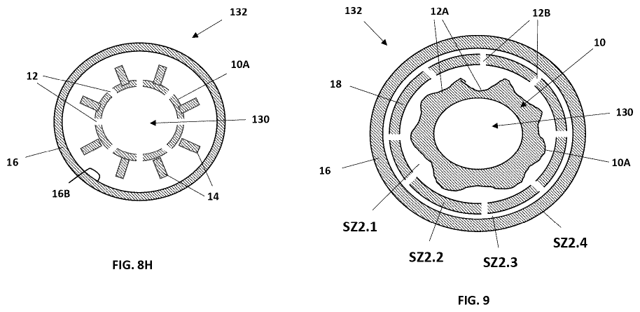

FIGS. 8A to 8H exemplify embodiments of the technique of the present disclosure utilizing multi-wall mold regions and structures 132, i.e. utilizing the metal-facing zone Z1/proximate wall 10 including the spaced-apart weak sites 12, and a metal-nonadjacent zone Z2 (16) which surrounds the zone Z1. This metal-nonadjacent zone Z2 surrounds the proximate wall 10 and includes an air gap sub-zone SZ2.1 interfacing the metal-facing zone Z1 and the sub-zone SZ2.2 in the form of an external closed-loop wall 16. The external wall 16, which is preferably configured from MMT1 type material, but may be of MMT2 or MMT3 material type. The metal-nonadjacent zone Z2 (formed by air gap SZ2.1 and wall 16) provides additional support for the proximate wall 10 in cases where the proximate wall expands under exerted pressure of the expanding metal.

The proximate wall 10 may be configured as in in the above-described examples of the single-wall mold. As shown in the specific not limiting examples of FIGS. 8A-8G, the proximate wall 10 may include various weak site arrangements, e.g., the arrangements of spaced-apart weak sites 12 formed by surface relief on the outer surface 10A of the proximate wall 10 and thus thickness variation of the wall 10 (FIGS. 8A-8C). Note that photo of FIG. 8C is taken during an interim production phase—showing the object 130, the stack of mold regions 132 after the deposition of the mold region of the current production layer and before the deposition of the respective object region. The weak sites 12 may be in the form of air gaps (FIGS. 8D and 8E); or the weak sites 12 may be formed by regions of the different material composition of the mold material (FIGS. 8F-8G).

It should be noted, although not specifically shown, that a volume of the air gap sub-zone SZ2.1 can remain void or can be at least partially filled with any suitable solid, semi-solid, gel, or foam material or composition. For example, a compressible material may be disposed between the inner surface 16B of the external wall 16 and the outer surface 10A of the proximate wall 10.

It should also be noted, although not specifically shown, that the metal-nonadjacent zone Z2 may include mainly external wall 16 which may be in contact with the proximate wall 10 along the entirety of its perimeter, or in separate discrete regions.

Considering the complete mold structure (that of the multiple production layers), the external closed-loop wall 16 may or may not be of the same height as the proximate wall of the mold structure. It may be of the height smaller or greater than that of the proximate wall 10. For example, the external wall 16 can surround only a certain portion of the multiple layers of the mold.

Thus, FIGS. 8A and 8B show the top and perspective views, respectively, of the exemplary mold 132 (or mold region) in which the proximate wall 10 is configured according to the mold described in FIGS. 4C and 4D. FIG. 8C shows a photo of the mold and object structure according to the configuration of FIGS. 8A and 8B where the weak sites 12 were created by non-uniform thickness on the perimeter along the outer surface of the proximate wall and where several production layers were accomplished, including repeated cycles of mold material deposition followed by the corresponding metal deposition.

It is expected that strong tensile stresses are developing in the mold region and structure due to the repeated heating and cooling cycles of the casted metal. The inventors analyzed the mold structure of FIG. 8C and confirmed that the proximate wall 10 collapsed along the predesigned weak points. However, the metal did not breach through the cracked mold structure, and one could proceed with the casting to produce the pre-designed object.

FIGS. 8D and 8E show the top and perspective views, respectively, of the exemplary mold region and corresponding structure 132 in which the proximate wall is configured according to the mold design described above with reference to FIGS. 5A and 5B.

FIGS. 8F and 8G show the top and perspective views, respectively, of the exemplary mold region and corresponding structure 132 in which the proximate wall is configured according to the mold design described above with reference to FIGS. 6A to 6F in which the weak sites 12 are made from a material of higher compressibility than the material of the spaces between the weak sites 12.

FIG. 8H shows the top view of a mold 132 in which the proximate wall includes the weak sites 12 and the fins 14 protruding from the outer surface of the proximate wall similar to the mold design described above with reference to FIG. 7A.

Reference is now made to FIG. 9 which shows a top view of an exemplary multi-zone mold region 132 which includes the metal-facing zone Z1 formed by a proximate closed-loop wall 10, and the metal-nonadjacent zone Z2 including sub-zones SZ2.2 and SZ2.4 formed by the external closed-loop wall 16 around the proximate wall, and an additional (intermediate) closed-loop wall 18 between the proximate and external walls and air gap sub-zones SZ2.1 and SZ2.3. Generally, in such configuration, either one or both of the proximate and intermediate walls 10 and 18 is/are configured with the arrangement of the spaced-apart relatively weak sites 12. In the specific not limiting example of FIG. 9, both of these walls 10 and 18 are configured with the weak sites 12.

Also, in the example of FIG. 9, the proximate wall 10 includes the arrangement of weak sites 12A provided by the variation of the wall thickness resulted from the surface relief of the outer surface 10A, and intermediate wall 18 includes the arrangement of weak sites 12B provided by air gaps between the segments of the wall 18. It should, however, be understood that any of the above-described implementations of the arrangement of spaced-apart relatively weak sites can be used in either one or both of the proximate and intermediate walls 10 and 18.

It should also be noted that in the multi-wall mold region configuration, e.g., as illustrated in FIG. 9, any suitable combination of mold material compositions can be used. For example, the external wall 16 may be constructed from the mold material composition having the same material properties as the proximate wall 10 (MMT1 material) and the intermediate wall 18, or the external wall 16 may be constructed from the mold material having material properties different from material properties of the mold material of the proximate wall 10 and/or the intermediate wall 18.

Thus, the present disclosure provides a novel effective technique for use in the additive metal casting, in which production layers are successively constructed by material deposition processes, where each layer includes one or more mold regions surrounding respective one or more object regions. The deposition processes and conditions for the mold and metal materials are properly synchronized, while the mold material(s) deposition is controllably performed, in accordance with the predetermined building plan, to create, in at least some of the production layers or preferably in all the productions later, the mold region(s) having an arrangement of spaced-apart sites of relatively weak mechanical properties relative to spaces between them. The arrangement of the spaced-apart relatively weak sites is selected in accordance with the properties of the metal object and the process and conditions of molten metal deposition in the object region(s).

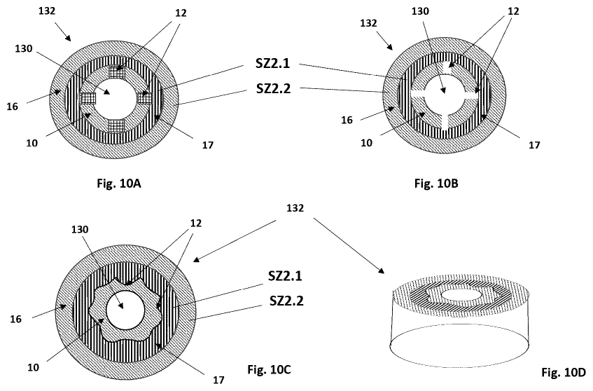

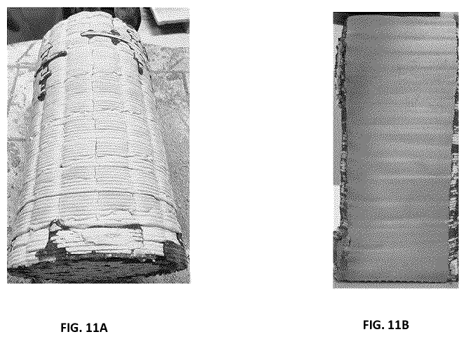

FIG. 10A to FIG. 10D exemplify various configurations of the mold region 132 including the metal-facing zone Z1 and the metal-nonadjacent zone Z2 including multiple sub-zones. Generally, these examples are similar to those of FIGS. 8F-8G, 8D-8E and 8A-8B but in which the air gap sub-zones SZ2.1 are filled with a compressible filler 17 placed between the proximate wall 10 (metal-facing zone Z1) and the external wall 16 (metal-nonadjacent sub-zone SZ2.2). The proximate wall 10 is configured with spaced apart sites 12 of relatively weak mechanical properties (weak/breathing points) providing (i) efficient distribution/relief of tensile stresses, and (ii) efficient transfer of residual compressive stresses to the compressible filler 17 in the sub-zone SZ2.1. The strong external wall 16 serves as a support for the compressible filler 17 during compression.

FIGS. 11A and 11B show photos of a metal object fabricated according to embodiments of the present disclosure. During fabrication, the metal object, having a diameter of 100 mm expanded about 1 mm in diameter over 1000 degrees Celsius.

FIG. 11A shows the metal object within the proximate wall of the mold structure. Other parts of the mold structure were removed and not shown in FIG. 11A. FIG. 11B shows the metal object part with the mold structure being partially removed. As can be seen, the mold structure exhibits several cracks along planned weak sites and somewhat peeled mold structure after the casting process is complete. Nevertheless, none of the cracks resulted in a breach of the mold structure by the molten metal. As can be seen, the surface of the object, defined by the mold structure, is free of leaking marks.

It should be noted that the techniques of the present disclosure can be utilized in any molding technique (i.e. mold deposition technique). Aspects of this technique are disclosed herein mainly with reference to the use of ceramic-based material for in-situ mold deposition. The present disclosure is not limited to this molding technique and can be implemented with other, in-situ or ex-situ molding techniques, as well as not limited to the use of ceramic-based material.

As a non-limiting example, the technique of the present disclosure can be implemented using the in-situ binder jetting molding technique disclosed in co-pending U.S. Patent Application No. 63/315,096, assigned to the assignee of the present application and incorporated herein by reference.

For example, the binder jetting mold construction system may comprise a mold powder provision system, a mold binder dispensing system and a mold powder removal system controllably operable together as the mold provision device to form one or more mold regions (configured as described above with the arrangement of spaced-apart relatively weak sites) defining one or more respective object regions in a production layer and is configured to receive molten metal deposited to each of said one or more object regions; and a control system configured as described above to operate said mold powder provision system, mold binder dispensing system and mold powder removal system in accordance with the predetermined building plan (indicative of geometric layout of the one or more object regions in each of the production layer and/or material and geometrical properties of said arrangement of the spaced-apart relatively weak sites of the mold region in each of the production layers and/or mold deposition process parameters and/or surface treatment parameters and conditions of surface treatment of the mold region, as well as synchronization data for the mold regions and object regions formation in the production layers. In such binder jetting mold construction system, the mold powder provision system is configured to provide one or more current mold powder layers; the mold binder dispensing system is configured to form one or more current mold regions within each of the one or more current mold powder layers by selectively dispending particles of one or more binding agents that bond some mold powder particles of the current mold powder layer; the mold powder removal system is configured to remove mold powder particles located within a certain area of each of the one or more current mold powder layers, the certain area is defined by at least some of the one or more current mold regions.

In such binder jetting mold construction system configured to implement the technique of the present disclosure, the mold powder provision system, mold binder dispensing system and mold powder removal system are controllably operable, in accordance with said predetermined building plan, to create each mold region, in each production layer, by constructing the mold region while varying one or more parameters and conditions or dispensing particles of one or more binding agents, prior to depositing the molten metal to form the respective object region of the current production layer, such that the mold region comprises a predetermined arrangement of spaced-apart sites of relatively weak mechanical properties relative to spaces between said sites within said mold material, said arrangement of the spaced-apart sites being selected in accordance with properties of the metal object and molten metal deposition.

Following another non-limiting example, the technique of the present disclosure can be implemented using the ex-situ sand molding technique disclosed in co-pending U.S. patent application Ser. No. 17/720,335, assigned to the assignee of the present application and incorporated herein by reference. The mold regions may be generated using sand and are enclosed by respective frames. The mold regions may be generated ex-situ and be placed/brought e.g., by a travel unit (a robot, for example) that hold and carry the frames, one by one, to the appropriate location(s) at each of the production layers. Once the frame is placed appropriately, the respective object region is fabricated.

Each mold region may comprise one or more replaceable material layers. The replaceable material would be replaced by molten metal upon object region fabrication. The replaceable material may be decomposed in a presence of the molten metal. Alternatively, the in a presence of the molten metal may be removed prior to molten metal deposition, for example using mechanical, chemical-based, temperature-based techniques.

The sand mold regions may be generated while varying one or more parameters and conditions between one frame to the other, such that the mold region comprises a predetermined arrangement of spaced-apart sites of relatively weak mechanical properties relative to spaces between said sites within the sand, said arrangement of the spaced-apart sites being selected in accordance with properties of the metal object and molten metal deposition.

As used throughout the specification, the terms “metal” or “metallic” refers to any metals and/or mellitic alloys which are suitable for melting and casting, for example, ferrous alloys, aluminum alloys, copper alloys, nickel alloys, magnesium alloys, and the like.

Any reference in the specification to a method should be applied mutatis mutandis to a system capable of executing the method and should be applied mutatis mutandis to a non-transitory computer-readable medium that stores instructions that, once executed by a computer, result in the execution of the method. Any reference in the specification to a system should be applied mutatis mutandis to a method that may be executed by the system and should be applied mutatis mutandis to a non-transitory computer-readable medium that stores instructions that may be executed by the system.

The terms “front,” “back,” “top,” “bottom,” “over,” “under”, and the like in the description and in the claims, if any, are used for descriptive purposes and not necessarily for describing permanent relative positions. It is understood that the terms so used are interchangeable under appropriate circumstances such that the embodiments of the present disclosure described herein are, for example, capable of operation in other orientations than those illustrated or otherwise described herein.

The subject matter regarded as the technique of the present disclosure is particularly pointed out and distinctly claimed in the concluding portion of the specification. The technique of the present disclosure, however, both as to organization and method of operation, together with objects, features, and advantages thereof, may best be understood by reference to the detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or operations and stages than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the technique of the present disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the present disclosure.

1. A mold construction system for use in additive manufacturing of a metal object, the mold construction system comprising: at least one mold provision device which is controllably operable to form one or more mold regions defining one or more respective object regions in a production layer and is configured to receive molten metal deposited to each of said one or more object regions; and a control system configured to operate said at least one mold provision device in accordance with a predetermined building plan,
wherein said at least one mold provision device is controllably operable, in accordance with said predetermined building plan, to create each mold region of each production layer with at least one metal-facing zone configured to define at least one cavity forming the object region to receive the molten metal therein, and
wherein said at least one metal-facing zone of the mold region comprises a predetermined arrangement of spaced-apart sites of relatively weak mechanical properties relative to spaces between said sites within said mold material, said arrangement of the spaced-apart sites being selected in accordance with properties of the metal object and molten metal deposition.

2. The system according to claim 1, wherein the metal-facing zone of the mold region has a closed-loop part defining the cavity forming the respective object region.

3. The system according to claim 1, wherein said mold provision device is controllably operable to create the mold region comprising at least one metal-nonadjacent zone around said at least one metal-facing zone.

4. The system according to claim 3, wherein the metal-nonadjacent zone comprises two or more adjacent sub-zones differently spaced from the metal-facing zone, said two or more sub-zones include at least two locally adjacent sub-sones having different mechanical properties.

5. The system according to claim 1, wherein the arrangement of said spaced-apart sites is formed by a varying width of the metal-facing zone, the sites of the relatively weak mechanical properties being defined by relatively thinner segments of the metal-facing zone.

6. The system according to claim 5, wherein the arrangement of said spaced-apart sites is in the form of a varying width of the metal-facing zone forming a surface relief along an outer surface of said metal-facing zone, the spaced-apart sites of the relatively weak mechanical properties being formed by segments of the metal-facing zone having relatively small width.

7. The system according to claim 1, wherein said at least one metal-facing zone has one of the following configurations: (i) comprises said spaced-apart sites formed by air gaps spaced by segments of said metal-facing zone; (ii) comprises said spaced-apart sites formed from the mold material of first material properties and the spaces between said sites are formed from the mold material of second material properties being different from the first material properties; and (iii) comprises said spaced-apart sites formed from the mold material of first material properties and the spaces between said sites are formed from the mold material of second material properties being different from the first material properties.

8. The system according to claim 1, wherein said at least one metal-facing zone comprises said spaced-apart sites formed from the mold material of first material properties and the spaces between said sites are formed from the mold material of second material properties being different from the first material properties, said spaced-apart sites comprising the first material properties providing relatively high compressibility as compared to compressibility provided by the second material properties of the spaces between the sites.

9. The system according to claim 8, characterized by one of the following: (a) said first material properties define relatively low material density of the mold material as compared to material density defined by the second material properties of the spaces between the sites; said spaced-apart sites are formed from the mold material of a first material composition and the spaces between said sites are formed from the mold material of a second material composition different from the first material composition.

10. The system according to claim 1, wherein said at least one mold provision device is controllably operable, in accordance with said predetermined building plan, to carry out one of the following:
create the arrangement of the spaced-apart sites in a successive mold region of a successive production layer positionally aligned with the arrangement of the spaced-apart sites in a preceding mold region in the preceding production layer;
create the arrangement of the spaced-apart sites in a successive mold region of a successive production layer is laterally shifted with respect to the arrangement of the spaced-apart sites in a preceding mold region of the preceding production layer; and
create the arrangement of the spaced-apart sites in a successive mold region of a successive production layer is different from the arrangement of the spaced-apart sites in a preceding mold region of a preceding production layer.

11. The system according to claim 1, wherein said mold provision device is controllably operable to create the mold region of each of at least some of the production layers comprising an array of supporting fins arranged in a spaced-apart relationship along an outer surface of the metal-facing zone, each of the supporting fins extending in a direction from said outer surface from a location aligned with a space between the spaced-apart sites.

12. The system according to claim 11, wherein said array of the supporting fins has one of the following configurations: the supporting fins are spaced from the outer surface of the metal-facing zone; or the supporting fins are constructed as protrusions from the outer surface of the metal-facing zone.

13. The system according to claim 11, wherein the supporting fins have at least one of the following configurations: (i) the supporting fins comprise fins having substantially rectangular cross section; (i) the supporting fins comprise fins having a varying profile along a lateral cross section of the fin; (iii) the supporting fins comprise fins having a varying profile along a vertical cross section of the fin.

14. The system according to claim 3, wherein said mold provision device is controllably operable to create the mold region comprising said metal-nonadjacent zone which is spaced-apart from said metal-facing zone by an air gap.

15. The system according to claim 14, wherein the mold region has one of the following configurations:
said metal-facing and metal-nonadjacent zones of the mold region are constructed from the mold material of the same material properties;
said metal-facing and metal-nonadjacent zones of the mold region are constructed from the mold material of different material properties;
said metal-nonadjacent zone comprises first and second sub-zones spaced-apart between them by an air gap, wherein the first sub-zone interfacing the air gap between the metal-facing zone and the metal-nonadjacent zone comprising an arrangement of spaced-apart sites of relatively weak mechanical properties as compared to spaces between them along said first sub-zone.

16. The system according to claim 3, wherein said mold provision device is controllably operable to create the mold region comprising said metal-nonadjacent zone, wherein the metal-nonadjacent zone comprises a number of sub-zones comprising a first sub-zone interfacing with the metal-facing zone being configured with mechanical properties different from mechanical properties of the metal-facing zone.

17. The system according to claim 16, wherein the metal-nonadjacent zone is characterized by at least one of the following:
said first sub-zone of the metal-nonadjacent zone has significantly higher compressibility than that of the metal-facing zone; and
the metal-nonadjacent zone further comprises a second sub-zone interfacing the first sub-zone, said first and second sub-zones have respectively relatively high and low compressibility.

18. The system according to claim 14, wherein said metal-nonadjacent zone comprises first and second sub-zones spaced-apart between them by an air gap, wherein the first sub-zone interfacing the air gap between the metal-facing zone and the metal-nonadjacent zone comprising an arrangement of spaced-apart sites of relatively weak mechanical properties as compared to spaces between them along said first sub-zone, the arrangement of the spaced-apart sites of relatively weak mechanical properties in the metal-facing zone being different from the arrangement of spaced-apart sites of relatively weak mechanical properties in the first sub-zone of the metal-nonadjacent zone.

19. The system according to claim 1, wherein said mold material comprises ceramic-based material.

20. The system according to claim 1, wherein said mold material comprises mold powder bound by mold binding material.

21. The system according to claim 1, wherein said mold provision device comprises one or more traveling mold depositors, each traveling in a horizontal plane according to a predetermined trajectory and being associated with one or more mold material reservoirs.

22. The system according to claim 21, wherein said mold provision device comprises is characterized by at least one of the following:
said mold provision device comprises one or more extruders each in fluid communication with said one or more traveling depositors; and
each of said one or more traveling depositors comprises at least one of the following: stirrers, tubing, and tubing loop configured to perform continuous circulation of the mold material not currently involved in deposition process.

23. The system according to claim 1, comprising a build table configured to be placed in a temperature-controlled environment.

24. The system according to claim 21, configured to provide relative displacement between said one or more traveling depositors and the build table.

25. The system according to claim 1, wherein said mold provision device is configured and operable to create the mold region using one or more mold material deposition iterations.

26. The system according to claim 1, further comprising a surface treatment system configured and operable to apply one or more surface treatments to the mold region.

27. The system according to claim 26, wherein the surface treatment system is configured and operable to carry out at least one of the following:
apply temperature treatment to the mold region to partially or fully cure mold material in said mold region;
apply temperature treatment to the mold region after each of one or more mold deposition iterations performed by the mold provision device while creating the mold region; and
perform mechanical surface treatment of at least a part of the mold region.

28. The system according to claim 26, wherein the surface treatment system is configured and operable to perform mechanical surface treatment of at least a part of the mold region, including surfaces of the metal-facing zone facing said cavity defined by the mold region.

29. A production part comprising: a stack of production layers, each of the production layers comprising: one or more object regions of a metal object, each object region being surrounded by a mold region having at least a metal-facing zone, wherein a surface of the metal object in said object region and a facing surface of the metal-facing zone of the mold region are physically coupled between them, and wherein at least the metal-facing zone of the mold region has a distribution of spaced-apart sites of relatively weak mechanical properties as compared to their surroundings within said metal-facing zone of the mold region.

30. An additive casting system for additively casting of a metallic object by producing multiple production layers having mold regions and object regions within cavities defined by the mold regions, one current production layer after the other on a movable build table up to a top production layer, the system comprising:
the mold construction system of claim 1, and
an object construction device configured and operable to construct each current production layer by depositing molten metal in each of one or more object regions defined by each of the respective one or more mold regions in said current production layer.

31. The additive casting system according to claim 30, wherein said object construction device comprises one or more molten metal depositors; and a control system configured to operate said one or more molten metal depositors in accordance with a predetermined building plan which is indicative of the following: geometric layout of the one or more object regions in each of the production layers; and synchronization data for the mold regions and object regions formation in the production layers.

32. A method for use in additive manufacturing of a metal object, the method comprising:
constructing successive production layers, each including a number of mold regions associated with a respective number of object regions, such that each mold region comprises a metal-facing zone having a closed-loop part configured to define a cavity forming the respective object region to receive molten metal therein, wherein the constructing of each production layer is controllably performed in accordance with a predetermined building plan, by carrying out the following:
for each production layer, prior to deposition of molten metal material in the number of object regions, creating said number of mold regions, by depositing a mold material in said number of mold regions while varying one or more of mold material deposition parameters and conditions within at least the metal-facing zones of the mold regions, to thereby form in the mold region a predetermined arrangement of spaced-apart sites of relatively weak mechanical properties relative to spaces between said sites within said mold region, said arrangement of the spaced-apart sites being selected in accordance with properties of the metal object and molten metal deposition process.
